(19) United States
(12) Patent Application Publication
(10) Pub. No.: US 2009/0272949 A1
(43) Pub. Date: Nov. 5, 2009

(54) Method for Producing Metal Oxide Nanoparticles Encapsulated with Conducting Polymers

(75) Inventor: Daniel A. Buttry, Tempe, AZ (US)

Correspondence Address: JEFFREY B. OSTER, 8339 SE 57TH ST, MERCER ISLAND, WA, 98040, US

(73) Assignee: The Blue Sky Group

(21) Appl. No.: 12/408,648

(22) Filed: Mar. 20, 2009

Related U.S. Application Data
(60) Provisional application No. 61/038,276, filed on Mar. 20, 2008.

(51) Int. Cl. H01B 1/12

(52) U.S. Cl. 252/519.34; 252/519.33; 977/773

(57) ABSTRACT

There is disclosed a method for producing metal oxide nanoparticles that are capped or otherwise encapsulated with conducting polymers. There is further disclosed a method for using metal oxide nanoparticles that are capped or encapsulated with conducting polymers in batteries and other energy storage devices. There is further disclosed a battery or other energy storage device having a cathode made from metal oxide nanoparticles capped or encapsulated with conducting particles. More particularly the battery is a secondary lithium battery.

This patent application claims priority from U.S. Provisional Patent Application 61/038,276 filed 20 Mar. 2009.

### GOVERNMENT RIGHTS

This invention was supported, in part, by the Department of Energy and the National Science Foundation. As such, the U.S. Government has certain rights to this invention.

### TECHNICAL FIELD

The present disclosure provides a method for producing metal oxide nanoparticles that are capped or otherwise encapsulated with conducting polymers. The present disclosure further provides a method for using metal oxide nanoparticles that are capped or encapsulated with conducting polymers in batteries and other energy storage devices, or as catalysts in fuel cells or other catalyzed processes. The present disclosure further provides a battery or other energy storage device having a cathode made from metal oxide nanoparticles capped or encapsulated with conducting polymers. More particularly the battery is a secondary lithium battery.

### BACKGROUND

Recently, rechargeable batteries have found applications in various fields such as electronics. As a novel battery of high power and high energy density, in particular, lithium batteries featuring high electromotive force derived from oxidation/reduction of lithium in the nonaqueous electrolyte have come into wide use. There is a need in battery technology, particularly lithium ion batteries, for better cathode materials. For example, in the area of lithium secondary batteries, there is a need for cathode materials that are in good contact with a matrix material that itself is in good electrical contact with the current collector.

Various sulfides and oxides have been proposed as cathode materials of lithium batteries. Compound oxides and amorphous compounds have also been proposed. For example, Japanese Patent Unexamined Publication No. 59-134561/1984 discloses a cathode active material composed of a solid solution prepared by adding phosphorus pentaoxide to vanadium pentaoxide and burning the resulting mixture, followed by rapid quenching. Japanese Patent Unexamined Publication No. 2-33868/1990 discloses a cathode formed of an amorphous powder prepared by melting and rapidly quenching a mixture of vanadium pentaoxide and 30 mol % or less of phosphorus pentaoxide. Further, Japanese Patent Unexamined Publication No. 62-176054/1987 proposes a lithium battery comprising a ternary oxide compound consisting of V₂O₅, Li₂O and P₂O₅ as a cathode material. Even if these cathode materials are used, however, the problem can not be solved that the repetition of charge and discharge causes a reduction in capacity. Accordingly, no cathode material satisfactory in cycle stability has been obtained yet.

Lithium secondary batteries, which can attain a higher energy density, especially the lithium secondary batteries using as a cathode active material, lithium composite oxide such as lithiated cobalt dioxide, lithiated nickel dioxide, and spinel lithium manganese oxide, and as an anode active material, a carbonaceous material that can be doped/undoped with lithium ions, have been developed. Since these lithium secondary batteries have inherently a large energy, maximum safety against abnormalities, such as an internal short circuit and an external short circuit, is required. Although poly(vinylidene fluoride (“PVDF”) and vinylidene fluoride copolymer have been used as the binder of the cathode composition for lithium secondary batteries, further improvement of safety against an external heating is required. When the suspension of polytetrafluoroethylene (“PTFE”), tetrafluoroethylene-hexafluoropropylene copolymer or tetrafluoroethylene-perfluoroalkylvinylether copolymer is independently used as a binder, the dispersibility of the resin is not good or the binding property with the current collector of a cathode is not sufficient. In case that the dispersion medium is water using, as a binder, the suspension dispersed in water medium such as a PTFE suspension, there is a problem that the battery capacity drops by the deterioration of a cathode active material.

Such lithium batteries have conventionally employed various metal oxides capable of absorbing and desorbing lithium ions, as the positive-electrode active material for use in the positive electrode. More recently, studies have been made on the use of manganese oxides, such as manganese dioxide, as the positive-electrode active material of the lithium battery because manganese oxides generally provide high discharge potentials and are inexpensive. Unfortunately, in charge/discharge processes of the lithium battery including the positive-electrode active material of manganese oxide, the manganese oxide is repeatedly expanded and contracted so that the crystal structure is destroyed. As a result, the battery suffers degraded charge/discharge cycle performance.

In recent attempts to improve the charge/discharge cycle performance of the lithium battery including the positive-electrode active material of manganese oxide, a variety of positive-electrode active materials have been proposed. For instance, Japanese Unexamined Patent Publication No.63-114064(1988) discloses a positive-electrode active material comprising a lithium-manganese complex oxide obtained from manganese dioxide and Li₂MnO₃. Japanese Unexamined Patent Publication No.1-235158 (1989) provides a positive-electrode active material comprising a complex oxide of lithium-containing manganese dioxide wherein lithium is incorporated in the crystal lattice of manganese dioxide. Further, Japanese Unexamined Patent Publication Nos.4-237970(1992) and 9-265984(1997) disclose positive-electrode active materials comprising lithium-manganese complex oxides with boron added thereto. Although the lithium batteries using the positive-electrode active materials are improved in the charge/discharge cycle performance to some degree, there still exists a problem that the positive-electrode active material reacts with the nonaqueous electrolyte in the battery, degrading the charge/discharge cycle performance. On the other hand, the recent electronics with higher performances demand a lithium battery further improved in the charge/discharge cycle performance.

### SUMMARY

The present disclosure provides a material comprising a metal oxide in a nanoparticle form encapsulated in a conducting polymer matrix. This material is suitable for use as a Li ion battery cathode or as a catalytic material. Preferably, the conducting polymer is selected from the group consisting of polypyrrole, poly(N-methyl pyrrole), poly(N-ethyl pyrrole), poly(N-propyl pyrrole), poly(N-butyl pyrrole), poly(N-pentyl pyrrole), poly(N-hexyl pyrrole), poly(N-phenyl pyrrole), polythiophene, poly(3-methoxy thiophene), poly(3-ethoxy thiophene), poly(3-propoxy thiophene), poly(3-ethyl thiophene), poly(3-propyl thiophene), poly(3-butyl thiophene), poly(3-pentyl thiophene), poly(3-hexyl thiophene), polyethylenedioxythiophene, polyaniline, poly(N-methyl aniline), poly(N-ethyl aniline), poly(N-propyl aniline), poly(N-butyl aniline), poly(N-pentyl aniline), poly(N-hexyl aniline) and combinations thereof. Preferably, the metal oxide is an oxide of a high valent transition metal precursor. Most preferably, the high valent transition metal precursor is selected from the group consisting of permanganate, vanadium pentaoxide, vanadium pentaoxide solutions, metavanadate, orthovanadate, vanadyl nitrate, vanadyl chloride, vanadyl-tris-ethoxide, vanadyl-tris-propoxide, vanadyl-tris-isopropoxide, vanadyl -tris-butoxide, NiO₂, NiO(OH₂), CoO₂, CoO(OH)₂, and combinations thereof. Preferably, the nanoparticles have a median diameter of from about 1 to about 50 nm when Mn is used as the transition metal. Preferably, larger nanoparticles have a median diameter of from about 50 to about 250 nm.

The present disclosure further provides a process for producing a nanocomposite comprising a metal oxide and a conducting polymer matrix, comprising:

(a) providing a metal oxide nanoparticle material, wherein the metal oxide is an oxide of a high valent transition metal precursor;

(b) oxidizing the metal oxide nanoparticle material with an oxidant in the presence of a conducting polymer monomer to a reaction product; and

(c) sonicating the reaction product to form the nanocomposite.

Preferably, the oxidizing reagent is a permanganate. Preferably, the metal oxide is mixed with, embedded within or encapsulated within the conducting particle. Preferably, the high valent transition metal precursor is selected from the group consisting of permanganate, vanadium pentaoxide, vanadium pentaoxide solutions, metavanadate, orthovanadate, vanadyl nitrate, vanadyl chloride, vanadyl-tris-ethoxide, vanadyl-tris-propoxide, vanadyl-tris-isopropoxide, vanadyl-tris-butoxide, NiO₂, NiO(OH₂), CoO₂, CoO(OH)₂, and combinations thereof. Preferably, the conducting polymer is selected from the group consisting of polypyrrole, poly(N-methyl pyrrole), poly(N-ethyl pyrrole), poly(N-propyl pyrrole), poly(N-butyl pyrrole), poly(N-pentyl pyrrole), poly(N-hexyl pyrrole), poly(N-phenyl pyrrole), polythiophene, poly(3-methoxy thiophene), poly(3-ethoxy thiophene), poly(3-propoxy thiophene), poly(3-ethyl thiophene), poly(3-propyl thiophene), poly(3-butyl thiophene), poly(3-pentyl thiophene), poly(3-hexyl thiophene), polyethylenedioxythiophene, polyaniline, poly(N-methyl aniline), poly(N-ethyl aniline), poly(N-propyl aniline), poly(N-butyl aniline), poly(N-pentyl aniline), poly(N-hexyl aniline) and combinations thereof.

### BRIEF DESCRIPTION OF THE FIGURES

FIG. 1 shows a monomer ethylenedioxythiophene is oxidized by permanganate. This reaction simultaneously produced MnO₂, which is the reduction product of permanganate, and polyethylenedioxythiophene (PEDOT), which is the oxidation product of EDOT. The reaction was done at elevated temperature under reflux conditions in acetonitrile.

FIG. 2 (left) shows a tapping mode-atomic force microscope (TM-AFM) image of the capped MnO₂ nanoparticles. This image was taken from a sample of the PEDOT-encapsulated MnO₂ nanoparticles that had been evaporated into the atomically flat surface of highly oriented pyrolytic graphite (HOPG), which is a common substrate for AFM measurements. FIG. 2 (right) shows a TM-AFM phase image demonstrating the core-shell nature of the capped nanoparticles.

FIG. 3 shows one of the MnO₂ nanoparticles as imaged using transmission electron microscopy (TEM). In this case the MnO₂ nanoparticle is seen, but the conducting polymer is not seen because of its poor contrast in the electron beam. In this case, which was synthesized using different conditions than those used to generate the nanoparticles shown in FIG. 2, the diameter of the MnO₂ part of the encapsulated nanoparticle is seen to be approximately 30 nm.

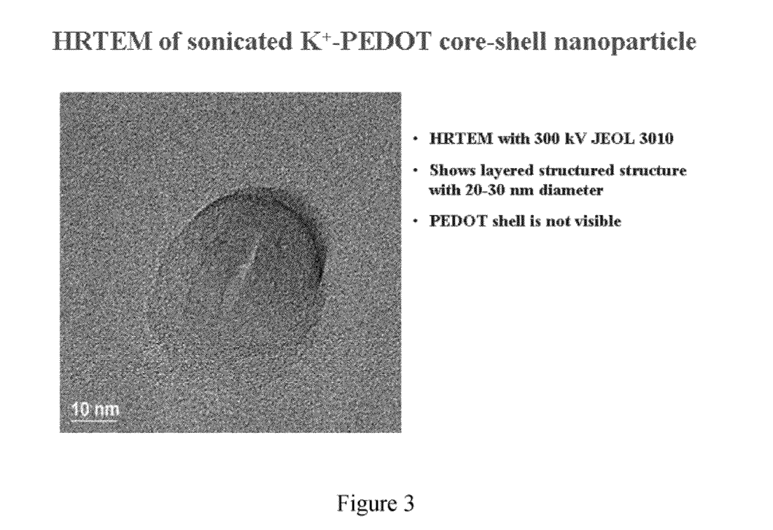

FIG. 4 shows a schematic of the synthesis of such larger nanoparticles. These nanoparticles can be produced using concentrations and molar ratios similar to those described above for the smaller nanoparticles, however, the reaction is done near room temperature (20-25 ° C.). This produces larger nanoparticles.

FIG. 5 shows a TEM of roughly 200 nm diameter nanoparticles that have MnO₂ embedded in PEDOT.

FIG. 6 shows another image of these nanoparticles in which the contrast is better, allowing the discrimination of the darker MnO₂-rich regions from the lighter PEDOT-rich regions.

FIG. 7 shows the results of sonication of the nanoparticles from FIG. 6. Sonication using a benchtop lab cleaner-sonicator breaks up the spherical nanoparticles, more easily revealing the MnO₂ fragments that were inside the spheres.

### DETAILED DESCRIPTION

The present disclosure provides a battery cathode comprising a metal oxide material that is encapsulated in a conducting polymer matrix. Good electrical contact between the active cathode energy storage phase, the matrix and the current collector facilitates the repeated and rapid delivery of charge to the metal oxide. The disclosure is exemplified by oxidative polymerization of any of a number of conducting polymers via oxidative polymerization of a precursor (monomer) by any of a number of high valent transition metal precursors and the types and sizes of the nanoparticles thereby produced. Examples of conducting polymers for which this approach was done include, but are not limited to, polypyrrole and its derivatives, polythiophene and its derivatives (such as polyethylenedioxythiophene), polyaniline and its derivatives, and many others. Examples of high valent transition metal precursors include permanganate and other high valent Mn reagents, high valent vanadium salts (such as vanadyl compounds), high valent nickel compounds, high valent cobalt compounds, and the like. These and related reagents are included here by example.

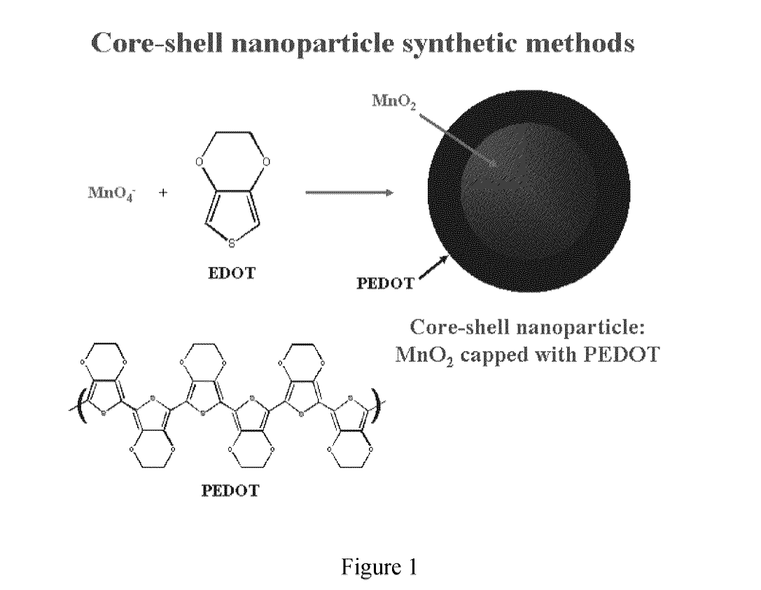

In one embodiment, the monomer that is a precursor to a conducting polymer, such as the ethylenedioxythiophene precursor shown in FIG. 1, was oxidized by permanganate. This reaction simultaneously produced MnO₂, which is the reduction product of permanganate, and polyethylenedioxythiophene (PEDOT), which is the oxidation product of EDOT. The reaction was done at elevated temperature, under reflux conditions in acetonitrile. Preferably, the acetonitrile was dried in order to remove water. The reaction was done at a molar ratio of EDOT to permanganate ranging from 100:1 to 1:100, respectively. Manipulation of this ratio controlled the size of the nanoparticles. For example, at higher EDOT:permanganate ratios the particles were generally smaller. Molar concentrations for the reagents dissolved in acetonitrile ranged from 0.01 mM to 4 M. PEDOT is a conducting polymer that can be doped into its conductive form by oxidation. MnO₂ is a redox active material that can be repeatedly reduced and reoxidized, making it suitable for use as a battery cathode material. It also can intercalate Li⁺cations during reduction, which makes it suitable for use as a secondary lithium battery cathode material. It is an unexpected result of this disclosure that nanoscale MnO₂ particles were produced that were capped or otherwise encapsulated with a conducting polymer phase.

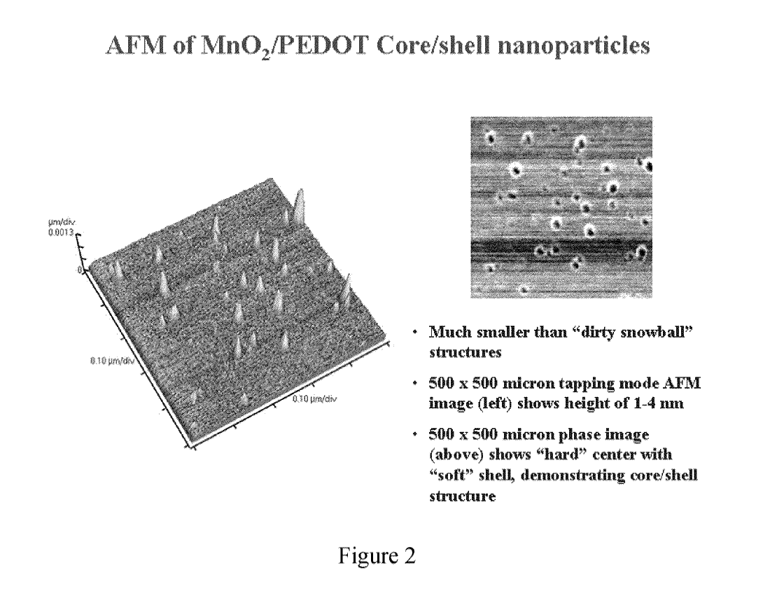

FIG. 2 (left) shows a tapping mode-atomic force microscope (TM-AFM) image of the capped MnO₂ nanoparticles. This image was taken from a sample of the PEDOT-encapsulated MnO₂ nanoparticles that had been evaporated into the atomically flat surface of highly oriented pyrolytic graphite (HOPG), which is a common substrate for AFM measurements. It shows that the height of the nanoparticles is in the range 1-4 nanometers. Note that the apparent width of the encapsulated nanoparticles in this image is much larger than the height. This is a known effect, and is related to the convolution of the large radius of curvature of the tip with the nanoparticle diameter. Thus, in AFM images of nanoparticles, only the measured height is a trustworthy measurement. FIG. 2 (right) shows a TM-AFM phase image demonstrating the core-shell nature of the capped nanoparticles. The contrast mechanism in phase images derives from the phase difference that is observed between the tapping of soft materials versus that observed when tapping hard materials. For example, the ringed image in the phase image AFM demonstrates that the harder MnO₂ is surrounded by a softer, conducting polymer shell. This is a clear demonstration of the MnO₂ core—PEDOT shell of these encapsulated nanoparticles.

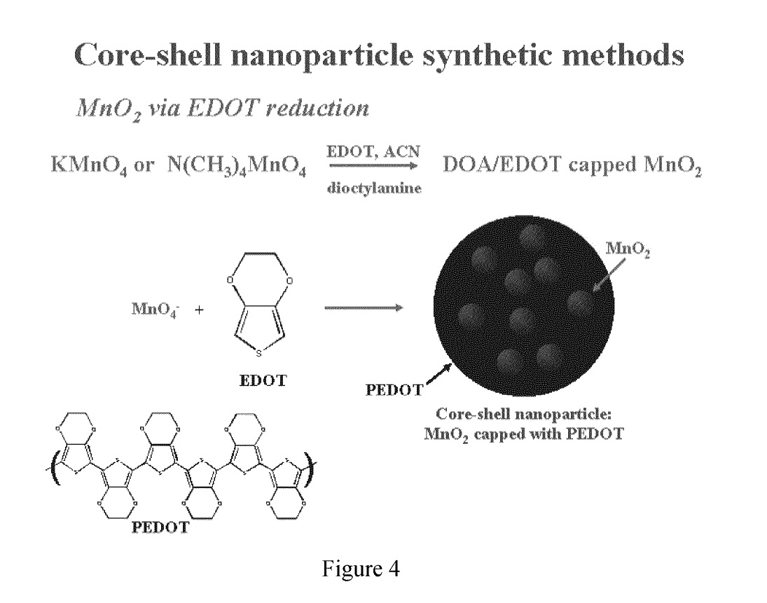

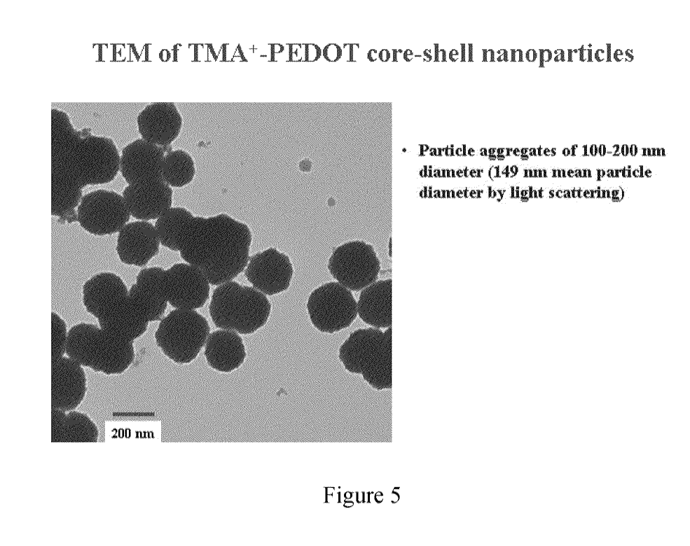

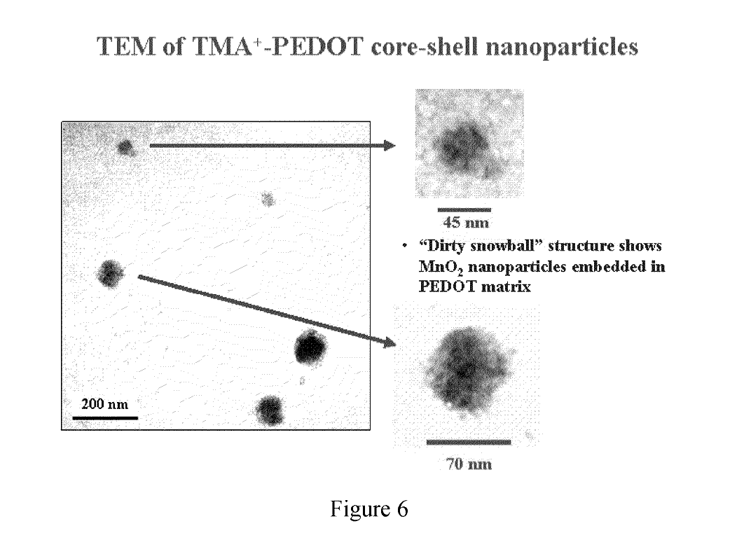

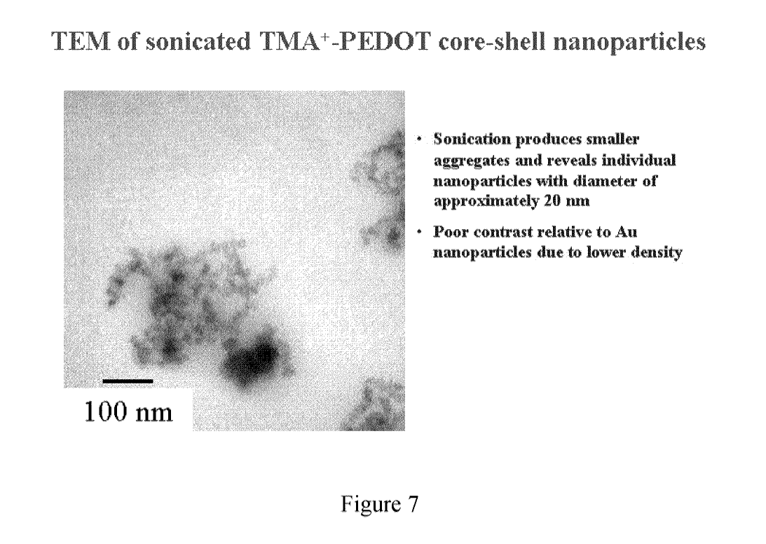

It is also possible to produce larger 50-250 nm diameter PEDOT particles that contain MnO₂ embedded in the PEDOT particle. FIG. 4 shows a schematic of the synthesis of such larger nanoparticles. These nanoparticles can be produced using concentrations and molar ratios similar to those described above for the smaller nanoparticles, however, the reaction is done near room temperature (20-25° C). This produces larger nanoparticles. FIG. 5 shows a TEM of roughly 200 nm diameter nanoparticles that have MnO₂ embedded in PEDOT. FIG. 6 shows another image of these nanoparticles in which the contrast is better, allowing the discrimination of the darker MnO₂-rich regions from the lighter PEDOT-rich regions. FIG. 7 shows the results of sonication of the nanoparticles from FIG. 6. Sonication using a benchtop lab cleaner-sonicator breaks up the spherical nanoparticles, more easily revealing the MnO₂ fragments that were inside the spheres.

There are other approaches to producing materials of this type. For example, it is possible to first make the MnO₂ nanoparticles by reduction with a chemical reducing agent such as an alcohol (e.g. n-butanol), and then later add the EDOT. In this case the intrinsic oxidizing power of the MnO₂ nanoparticles can oxidize the EDOT, producing a MnO₂-PEDOT core-shell material as described above. Thus, the EDOT need not necessarily serve as the initial reducing agent that produces the MnO₂ from the permanganate precursor. Similarly, the oxidizing agent that oxidizes the EDOT to PEDOT need not necessarily be the permanganate reagent. Other oxidizing agents can be used that serve to oxidize the EDOT or other conducting polymer precursor in the presence of a transition metal oxide nanoparticle.

Additional variations on this approach may include use of oxide nanoparticles that contain more than one transition metal. Still other variations on this approach may include the use of combinations of conducting polymer precursors such that conducting polymers that are synthesized from more than one monomeric precursor are produced. These two variations may be used together such that a metal oxide with more than one metal component is used with a conducting polymer synthesized from more than one monomeric precursor. In still another variation, other polymeric components may be added to the conducting polymer phase using a variety of synthetic approaches such as copolymerization. In this case, attractive features of the co-included polymer may enhance certain aspects of the battery performance. For example, inclusion of polyethyleneoxide (PEO) or related materials may facilitate Li⁺diffusion.

There are several features of the MnO₂-PEDOT combination of materials that are useful for secondary lithium batteries. First, the PEDOT is conductive in the same potential range as that for the redox reaction of MnO₂. Thus, the PEDOT can efficiently carry charge to and from the encapsulated MnO₂. Second, the PEDOT bears ether linkages to facilitate Li⁺transport, by virtue of favorable interactions between the ether groups and the Li⁺cations. Third, the encapsulation of the MnO₂ may prevent unwanted dissolution of the manganese from the oxide nanoparticle in either or both oxidation states that are relevant to the secondary battery cycling. Fourth, the elastic properties of the PEDOT polymer may reversibly accommodate the volumetric changes caused by changes in crystallographic unit cell associated with Li⁺insertion into the MnO₂ nanoparticle. Fifth, the small size of the MnO₂ nanoparticles implies that Li⁺need not diffuse large distances through the solid oxide phase, where diffusion rates are typically quite low. These various properties endow this new material with both rapid and reversible cycling behavior when used as a cathode material in a secondary lithium battery cathode.

An unexpected benefit of the disclosed cathode is that the metal oxide material, which is itself an active cathode material, is provided in a chemical form in which the metal oxide can be addressed electronically using the conducting polymer as an addressing medium, and where the metal oxide is also embedded in a relatively elastic medium that can accommodate volumetric changes as part of the lithium insertion reaction. This reaction serves as the charge storage reaction in a lithium secondary battery. In this example the manganese redox reaction between the Mn tetravalent state and the manganese trivalent state is facilitated by the fact that the MnO₂ nanoparticles are encapsulated in the polyethylenedioxythiophene (PEDOT) conducting polymer.

Additional variations in this approach may include the use of nanoscale materials with different shapes. For example, the metal oxide may be present as a nanoparticle with a roughly spherical shape as shown above. It may be present as a rod-shaped nanoscale object with variable aspect ratio. It may be present as a nanotube that is hollow with a variable wall thickness. It may be present as a platelet-shaped nanoscale object. It can be seen that there are many shapes and sizes of nanoscale objects for which the benefits described above will be relevant.

An additional variation in the approach is to carbonize or otherwise treat the conducting polymer(s) after the particles are formed. In this way, it increases the conducting of the surrounding carbon-based matrix without significantly affecting size and aspect ratio of the metal particles. This also increases effective density of the cathode material by altering the density of the conducting polymer matrix. This also increases surface activity of the metal particles in order to allow for their use as catalysts for fuel cells or other catalytic processes.

I claim:

1. A Li ion battery cathode material comprising a metal oxide nanoparticle mixed with or encapsulated within a conducting polymer matrix.

2. The Li ion battery cathode material of claim 1 wherein the conducting polymer is selected from the group consisting of polypyrrole, poly(N-methyl pyrrole), poly(N-ethyl pyrrole), poly(N-propyl pyrrole), poly(N-butyl pyrrole), poly(N-pentyl pyrrole), poly(N-hexyl pyrrole), poly(N-phenyl pyrrole), polythiophene, poly(3-methoxy thiophene), poly(3-ethoxy thiophene), poly(3-propoxy thiophene), poly(3-ethyl thiophene), poly(3-propyl thiophene), poly(3-butyl thiophene), poly(3-pentyl thiophene), poly(3-hexyl thiophene), polyethylenedioxythiophene, polyaniline, poly(N-methyl aniline), poly(N-ethyl aniline), poly(N-propyl aniline), poly(N-butyl aniline), poly(N-pentyl aniline), poly(N-hexyl aniline), and combinations thereof.

3. The Li ion battery cathode material of claim 1 wherein the metal oxide is an oxide of a high valent transition metal precursor.

4. The Li ion battery cathode material of claim 3 wherein the high valent transition metal precursor is selected from the group consisting of permanganate, vanadium pentaoxide, vanadium pentaoxide solutions, metavanadate, orthovanadate, vanadyl nitrate, vanadyl chloride, vanadyl-tris-ethoxide, vanadyl-tris-propoxide, vanadyl-tris-isopropoxide, vanadyl-tris-butoxide, NiO₂, NiO(OH₂), CoO₂, CoO(OH)₂, and combinations thereof.

5. The Li ion battery cathode material of claim 1 wherein the nanoparticles have a median diameter of from about 1 to about 50 nm when Mn is used as the transition metal.

6. The Li ion battery cathode material of claim 1 wherein larger nanoparticles have a median diameter of from about 50 to about 250 nm.

7. A process for producing a nanocomposite comprising a metal oxide and a conducting polymer matrix, comprising:
(a) providing a metal oxide nanoparticle material, wherein the metal oxide is an oxide of a high valent transition metal precursor;
(b) oxidizing the metal oxide nanoparticle material with an oxidant in the presence of a conducting polymer monomer to a reaction product; and
(c) sonicating the reaction product to form the nanocomposite.

8. The process for producing a nanocomposite comprising a metal oxide and a conducting polymer matrix of claim 7, wherein the oxidizing reagent is a permanganate.

9. The process for producing a nanocomposite comprising a metal oxide and a conducting polymer matrix of claim 7, wherein the metal oxide is mixed with, embedded within or encapsulated within the conducting particle.

10. The process for producing a nanocomposite comprising a metal oxide and a conducting polymer matrix of claim 7, wherein the high valent transition metal precursor is selected from the group consisting of permanganate, vanadium pentaoxide, vanadium pentaoxide solutions, metavanadate, orthovanadate, vanadyl nitrate, vanadyl chloride, vanadyl-tris-ethoxide, vanadyl-tris-propoxide, vanadyl-tris-isopropoxide, vanadyl-tris-butoxide, NiO₂, NiO(OH₂), CoO₂, CoO(OH)₂, and combinations thereof.

11. The process for producing a nanocomposite comprising a metal oxide and a conducting polymer matrix of claim 7, wherein the conducting polymer is selected from the group consisting of polypyrrole, poly(N-methyl pyrrole), poly(N-ethyl pyrrole), poly(N-propyl pyrrole), poly(N-butyl pyrrole), poly(N-pentyl pyrrole), poly(N-hexyl pyrrole), poly(N-phenyl pyrrole), polythiophene, poly(3-methoxy thiophene), poly(3-ethoxy thiophene), poly(3-propoxy thiophene), poly(3-ethyl thiophene), poly(3-propyl thiophene), poly(3-butyl thiophene), poly(3-pentyl thiophene), poly(3-hexyl thiophene), polyethylenedioxythiophene, polyaniline, poly(N-methyl aniline), poly(N-ethyl aniline), poly(N-propyl aniline), poly(N-butyl aniline), poly(N-pentyl aniline), poly(N-hexyl aniline) and combinations thereof.
